(19) United States
(12) Patent Application Publication
(10) Pub. No.: US 2015/0364866 A1
(43) Pub. Date: Dec. 17, 2015

(54) ELECTRICAL CORD PLUG EJECT MECHANISM

(71) Applicant: Brainwave Research Corporation, Woodbridge (CA)

(72) Inventors: Jean-Guy GAGNE, Etobicoke (CA); James W. ROGERS, Toronto (CA); Patrick BELANGER, British Columbia (CA)

(21) Appl. No.: 14/833,974

(22) Filed: Aug. 24, 2015

Related U.S. Application Data
(63) Continuation-in-part of application No. 14/587,881, filed on Dec. 31, 2014.
(60) Provisional application No. 62/043,091, filed on Aug. 28, 2014.
(60) Provisional application No. 61/923,318, filed on Jan. 3, 2014.

(51) Int. Cl. H01R 13/633; H01R 13/6581; H01R 13/66; H01R 13/70

(52) U.S. Cl. CPC H01R 13/633; H01R 13/70; H01R 13/6581; H01R 13/665

(57) ABSTRACT

A plug housing includes an ejector mechanism and a controller electrically coupled to the ejector mechanism for detaching electrical conductive blades of the plug from a mated connection with a female connector. In response to a switch signal from the controller, a solenoid is activated to release a latch in the mechanism, thereby permitting the force of a compressed spring to impel a structure outwardly from the plug. The controller may be located remotely from the plug and superimpose control signals to the plug over the power lines within the cord.

This is a continuation-in-part of application Ser. No. 14/587,881, filed Dec. 31, 2014 on behalf of inventors Jean-Guy Gagne, James Rogers and Patrick Belanger. The benefit of provisional application 61/923,318, filed Jan. 3, 2014 and provisional application 62/043,091, filed Aug. 28, 2014, is claimed under 35 U.S.C. 119(e).

### BACKGROUND

This disclosure is related to electrical cord and plug devices and, more particularly, to a mechanism for remotely controlling ejection of a plug from an outlet or from another cord or device to which the plug is connected.

A variety of electrical applications require a long electrical cord so that a user can operate an electrical appliance or other device at a relatively great distance from the power source. For example, vacuum cleaners are commonly provided with electrical cords that enable use over a large area, often extending to adjoining rooms. As another example, a long extension cord may be required for operation of a device at a location beyond the range of the cord originally provided with the device.

Upon completion of use, the operator typically needs to retrieve the connector plug for storage of the cord or for use of the device in another location. A pull on the cord by the user at the device location may not be sufficient to effect disconnection or, worse, damage the plug and outlet. Conventionally, disconnection of the plug from the power source occurs by the user physically traveling from the device to the remote location of the plug. Attempts to remotely control disconnection of a plug from an outlet have been prone to problems such as inadvertent disconnection, repetitive control pulsing that can damage or burn out the plug device, or lack of sufficient force to completely separate the plug from its receptacle.

A need exists for removal of an electrical plug from connection to a power source by a user situated at a device location remote from the plug. A further need is the ability for a user to remotely control disconnection of the plug so that retrieval of the plug and cord can be accomplished at the device location. Such an approach should be immune to inadvertent automatic disconnection or burn out of the control device. It may be desirable to remotely control both disconnection of the male plug of an extension cord from an outlet as well as disconnection of the female plug end of the extension cord from a user device. A further need exists for disconnection of a plug from an outlet in response to adverse conditions, such as an angular pull on the cord or overheating at the outlet.

### SUMMARY OF DISCLOSURE

The needs described above are fulfilled, at least in part, by a plug housing including an ejector mechanism and a manual controller electrically coupled to the ejector mechanism for detaching electrical conductive blades of the plug from a mated connection with a female connector. In response to a switch signal from the controller, a solenoid is activated to release a latch in the mechanism, thereby permitting the force of a compressed spring to impel a structure outwardly from the plug.

The structure may be configured as a shell with one or more sections that surround the conductive blades. The latch may be composed of a plurality of latch elements. In the latched position, an inward end of the shell is positioned between the latch elements and the spring, within the plug housing. A second spring biases the latch elements toward the latched position.

The solenoid is positioned within the plug aligned in a direction in traverse of the direction of the axis of the plug. When energized, the solenoid overcomes the force of the second spring to provide space for the compressed spring to impel the shell outwardly. A circuit board within the plug provides contacts for electrical connection to the solenoid and the conductive blades. The circuit board also provides for circuit elements that receive and process a received controller signal.

The manual controller signal may be generated at the site of the plug or at a site remote from the plug. For example, a switch may be provided at the plug to complete a circuit to the solenoid. The plug housing may include a wall portion that shields the switch from inadvertent manual activation. A switch may be provided at the far end of the cord or further along a connected power line. In response to switch deployment at the remote site, a communication signal is superimposed on the power lines for processing in the plug to cause solenoid energization. A tone generator may be included on the circuit board for processing a received analog signal, or a microcontroller may be included on the circuit board for processing a received data signal.

Alternatively, the solenoid may be positioned in the axial direction of the plug. The plunger of the solenoid is forced in the axial direction to unlatch the shell. In a further modification, the ejector structure may comprise an ejector plate having a surface area proximate the entire periphery of the plug housing. Holes in the surface surround the conductive blades. A rod extending inwardly from the ejector plate is fixed to an end of the solenoid plunger.

In an alternative approach, the ejector mechanism may use an ejector rod, the distal end of which is impelled from a retracted position at a predetermined distance within the plug housing to an extended position beyond the front of the plug housing. The spacing of the retracted ejector rod enables application of a greater ejection force than would be obtained with an ejector element that is flush with the front of the plug. The ejector rod is connected to a plunger that is under control of a solenoid for the ejection of the ejector rod. The retracted position of the ejector rod may be spaced from the front of the plug by a distance by which the length of the inner space of the plug housing exceeds the combined length of the ejector rod and plunger. A weighted element may be fixed to the plunger to provide added momentum for the ejection process. Activation of the solenoid may be obtained by manual operation of remote switch connected in series between the plug conductive blades and a control circuit within the plug. The control circuit may include a circuit board having a microprocessor thereon. The microprocessor may be programmed to output multiple solenoid activation pulses in response to a single remote trigger pulse and to limit the time of an output solenoid activation pulse to avoid damage to the solenoid.

A second solenoid may be provided for compound operation of the plunger. The second solenoid may be configured to provide a retracting force to the plunger. The microprocessor may be programmed to activate the solenoids alternatively in response to detection that ejection of the plug has not been completed. A cycle of alternative activation of the solenoids may continue until ejection of the plug has been successful. As an alternative, the second solenoid may configured to provide an ejection force to supplement the first solenoid.

In a further alternative, the solenoid(s) may be replaced by cylinder and piston arrangement, the piston serving as the ejector rod. A pressurized reservoir may be coupled to the cylinder through a control valve. Upon activation of the control valve, the valve is opened to apply pressure from the reservoir to the cylinder to drive the piston to the ejected state. Upon successful plug ejection, a second control valve can be activated to reduce the pressure. A spring, positioned between the piston and the front of the plug housing, impels the piston to its retracted state. The control valves may function under control of a microprocessor in response to receipt of the manual trigger. A compressor may be included in the plug housing to replenish the pressure within the reservoir.

Additional advantages of the present disclosure will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF DRAWINGS

Various exemplary embodiments are illustrated by way of example, and not by way of limitation, in the figures of the accompanying drawings in which like reference numerals refer to similar elements and in which:

FIGS. 1a-1i are illustrative of an embodiment of the disclosure;

FIGS. 1a and 1b are isometric views of an electrical cord and plug ejecting mechanism in retracted position and ejected position, respectively;

FIG. 1c is a top view of the retracted male plug shown in FIG. 1a;

FIG. 1d is a section view taken from FIG. 1c;

FIG. 1e is a detail view taken from FIG. 1d;

FIG. 1f is a top view of the extended male plug shown in FIG. 1b;

FIG. 1g is a section view taken from FIG. 1f;

FIG. 1h is a detail view taken from FIG. 1g;

FIG. 1i is an isometric view of a plurality of plugs in serial connection;

FIGS. 2a-2f are illustrative of a modification of the embodiment of the FIGS. 1a-1h;

FIG. 2a is a top view of a retracted male plug;

FIG. 2b is a section view taken from FIG. 2a;

FIG. 2c is a detail view taken from FIG. 2b;

FIG. 2d is a top view of the male plug shown in FIG. 2a as extended;

FIG. 2e is a section view taken from FIG. 2d;

FIG. 2f is a detail view taken from FIG. 2e;

FIGS. 3a-3h are illustrative of a different modification of the embodiment of the FIGS. 1a-1h;

FIGS. 3a and 3b are isometric views of an electrical cord and plug ejecting mechanism in retracted position and ejected position, respectively;

FIG. 3c is a top view of the retracted male plug shown in FIG. 3a;

FIG. 3d is a section view taken from FIG. 3c;

FIG. 3e is a detail view taken from FIG. 3d;

FIG. 3f is a top view of the male plug shown in FIG. 3a as extended;

FIG. 3g is a section view taken from FIG. 3f;

FIG. 3h is a detail view taken from FIG. 3g;

FIG. 4 is illustrative of an extended plug of FIGS. 1-3 incorporated in an extension cord reel;

FIG. 5 is illustrative of a plug of FIGS. 1-3 connected with a wall outlet;

FIG. 6 is illustrative of an extended plug of FIGS. 1-3 incorporated in a vacuum cleaner;

FIGS. 7a-7j are illustrative of another embodiment of the disclosure;

FIGS. 7a and 7b are back and front isometric views, respectively, of a plug with ejector in retracted position;

FIGS. 7c and 7d are back and front isometric view, respectively, of a plug with ejector in extended position;

FIG. 7e is a top view of the device shown in FIGS. 7a and 7b;

FIG. 7f is a section view taken from FIG. 7e;

FIG. 7g is a section view taken from FIG. 7f;

FIG. 7h is a top view of the device shown in FIGS. 7c and 7d;

FIG. 7i is a section view taken from FIG. 7h; and

FIG. 7j is a detail view taken from FIG. 7i;

FIG. 8 is a block diagram of circuit elements of plug units for ejection under analog control;

FIG. 9 is a block diagram of circuit elements of plug units for ejection under digital control;

FIGS. 10 and 11 are flow charts of operation for the block diagram elements of FIGS. 8 and 9;

FIGS. 12a-12h are illustrative of another eject plug embodiment;

FIG. 12a is an isometric view of eject plug 85;

FIGS. 12b-d are orthographic views of the eject plug shown in FIG. 12a;

FIG. 12e is a bottom view of the eject plug shown in FIGS. 12a-d in the eject state;

FIG. 12f is a section view taken from FIG. 12e;

FIG. 12g is a bottom view as FIG. 12e with the eject plug in the retracted state;

FIG. 12h is a section view taken from FIG. 12g.

FIGS. 13a-13d depict a modification of the embodiment of FIGS. 12a-12h;

FIG. 13a is a bottom view of the eject plug shown in the eject state;

FIG. 13b is a section view taken from FIG. 13a;

FIG. 13c is a bottom view as FIG. 13a with the eject plug in the retracted state;

FIG. 13d is a section view taken from FIG. 13c;

FIG. 14 is an isometric view of a female plug of an extension cord;

FIGS. 15a-b are section views of a compressed gas eject plug in the retracted and eject states respectively;

FIG. 16 is a section view of modification of the a compressed gas eject plug shown in FIG. 15 in the retracted state;

FIGS. 17a-b are section views of a reciprocating solenoid driven eject plug in the retracted and eject states respectively;

FIGS. 18a-c are section views of a progressive solenoid driven eject plug in three states;

FIG. 19a is a force versus plunger travel graph for a single solenoid; and

FIG. 19b is a force versus plunger travel graph for a progressive two solenoid assembly.

### DETAILED DISCLOSURE

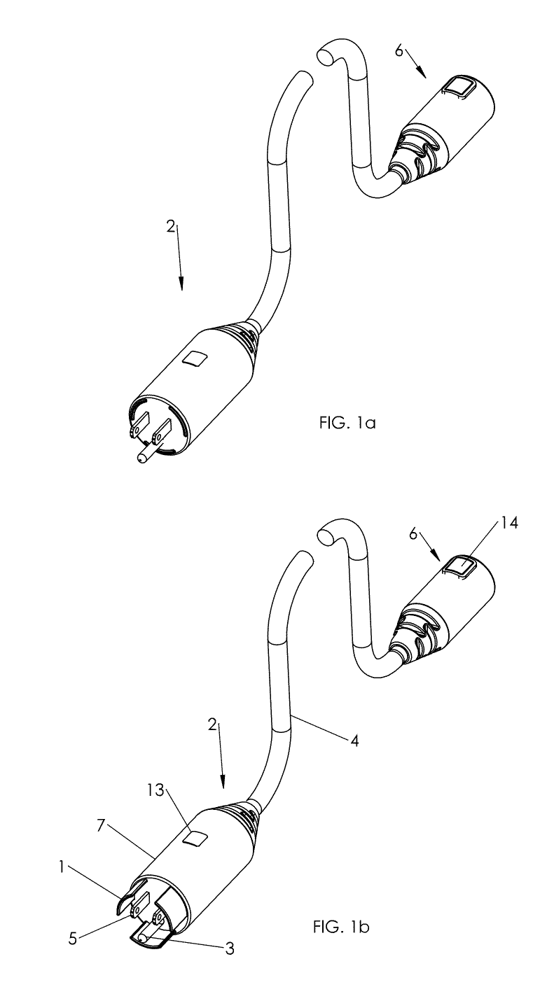

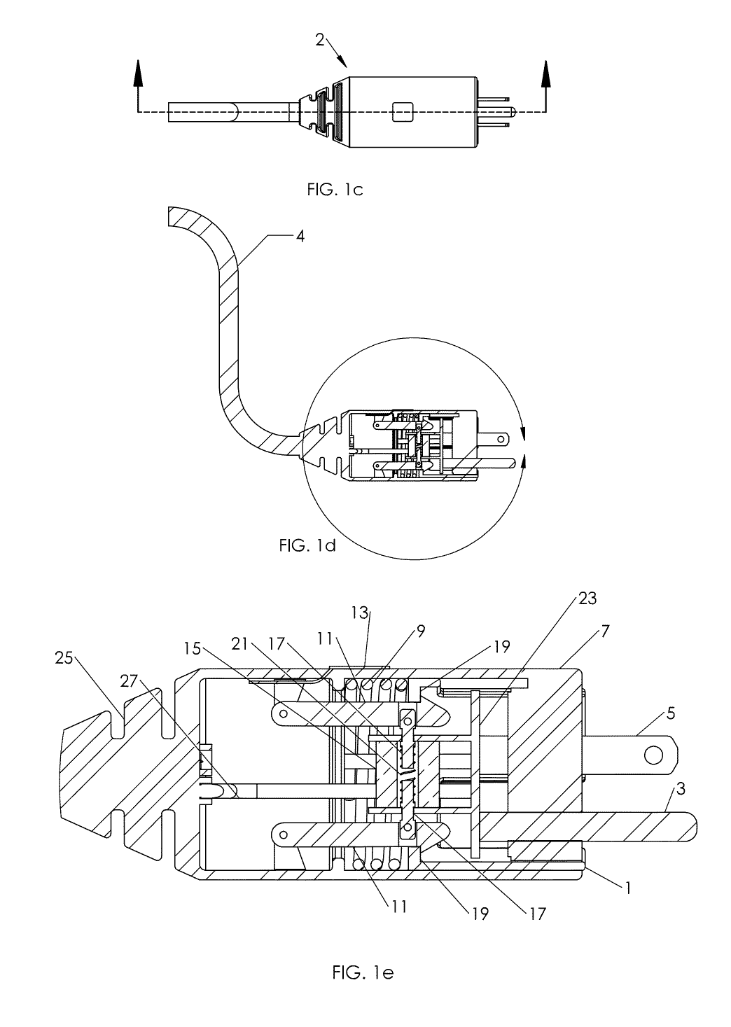

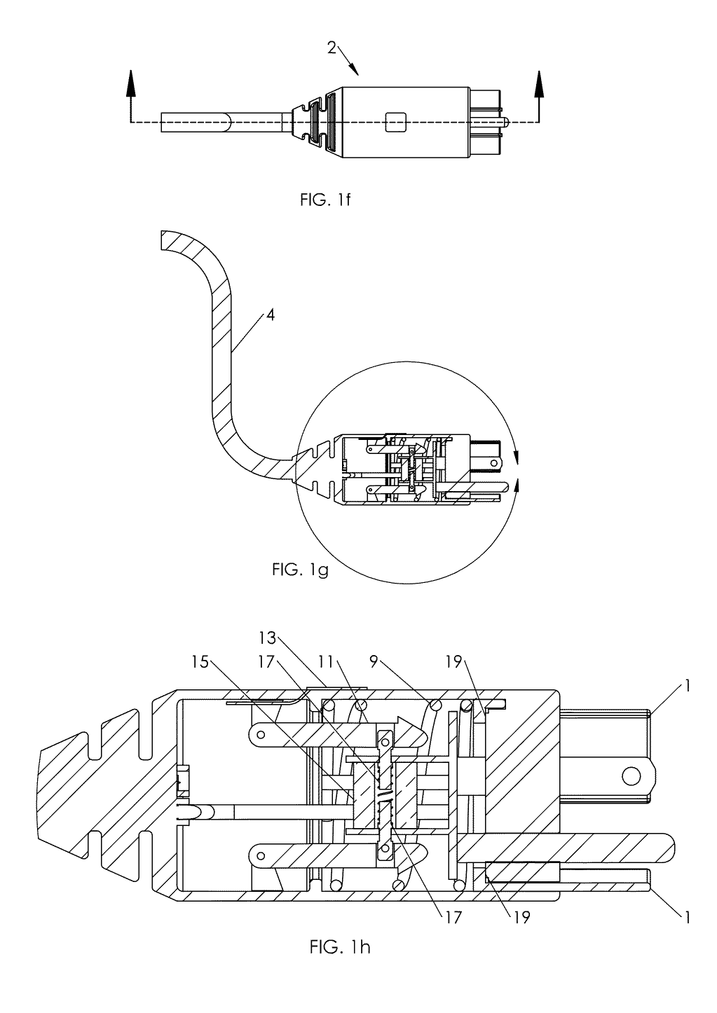

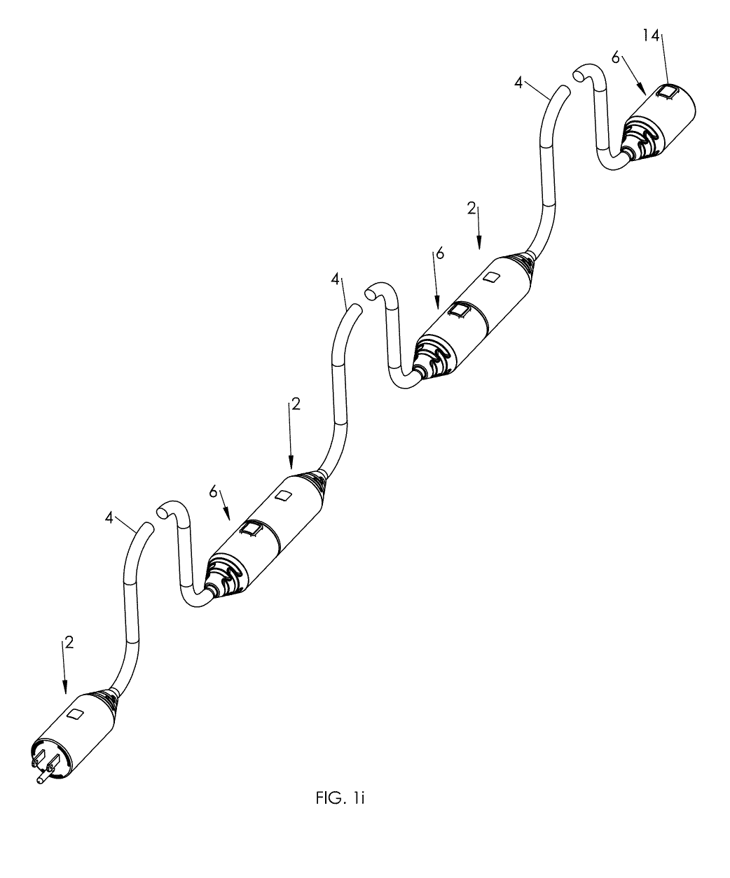

An electrical extension cord 2 having a cylindrical male plug 7 at one end and a female plug 6 is illustrated in FIGS. 1a and 1b. Conductive prongs 5 and ground prong 3 extend from plug 7. Shell 1, within plug 7, surrounds prongs 5. Shell 1 comprises sections formed in a cylindrical configuration with a surface area substantially corresponding in size to that of the circumference of the housing of plug 7. When shell 1 is retracted within plug 7, as shown in FIG. 1a, prongs 5 are able to mate with a female receptacle or plug to establish an electrical connection therewith. When shell 1 is extended from plug 7, as shown in FIG. 1b, a mated connection with plug 7 is precluded. Manual button 13 is tied to a switch component within plug 7. Manual button 14 is tied to a switch component within female plug 6. Components of plug 7 are shown in detail in FIG. 1e for the retracted position of shell 1 and in FIG. 1h for the extended position of shell 1. Depression of either button 13 or 14 effects ejection of plug 7 from the mated connection. Thus, ejection may be initiated at the connection site or initiated at the remote site of the female plug.

Referring to FIG. 1e, conducting wires and ground wires 27, only one of which is shown in the section, extend through strain relief 25, and are soldered to circuit board 23, the latter fixed within plug 7. Plug blades 5 and ground prong 3 are also mounted to circuit board 23, although they may alternatively be wired in a conventional manner. Solenoid 15, containing split plungers 17, is also mounted on circuit board 23. Windings of solenoid 15 are configured to pull plungers 17 toward each other when the solenoid is energized. Each plunger 17 is biased outwardly by spring 21 and pinned to an end of a respective latch 11. Latches 11 are also pinned to the outer structure of plug 7. Transverse surfaces 19 at the inward end of shell 1 are held in the retracted position by detents in latches 11 against the outward force of spring 9. As arranged in FIG. 1a, the plug may be inserted into a female receptacle for establishing electrical connection.

Shell 1, springs 9 and 21, solenoid 15, and latches 11 comprise an ejector mechanism for controlled removal of the plug from the electrical connection. Plug 7, in the ejected state, is shown in detail in FIG. 1h. In operation, ejection is activated by manual depression of button 13 of plug 7 or button 14 of plug 6. Deployment of each of these buttons effects a switched connection to energize solenoid 15. Armatures 17 overcome the outwardly biased force of spring 21, pulling latches 11 inward to clear the transverse surfaces 19 of shell 1. The expansion force of spring 9, unimpeded by latches 11, now impels shell 1 to its extended position, ejecting blades 5 and ground prong 3 from the mated connection. Solenoid 15 is de-energized pursuant the plug disconnection. Spring 21 again exerts sufficient force to return latches 11 to the initial position. The plug can be reinserted for a subsequent electrical connection. Shell 1 will be pushed inwardly against latches 11 to overcome the force of spring 9 until transverse surfaces 19 again are maintained by the latches.

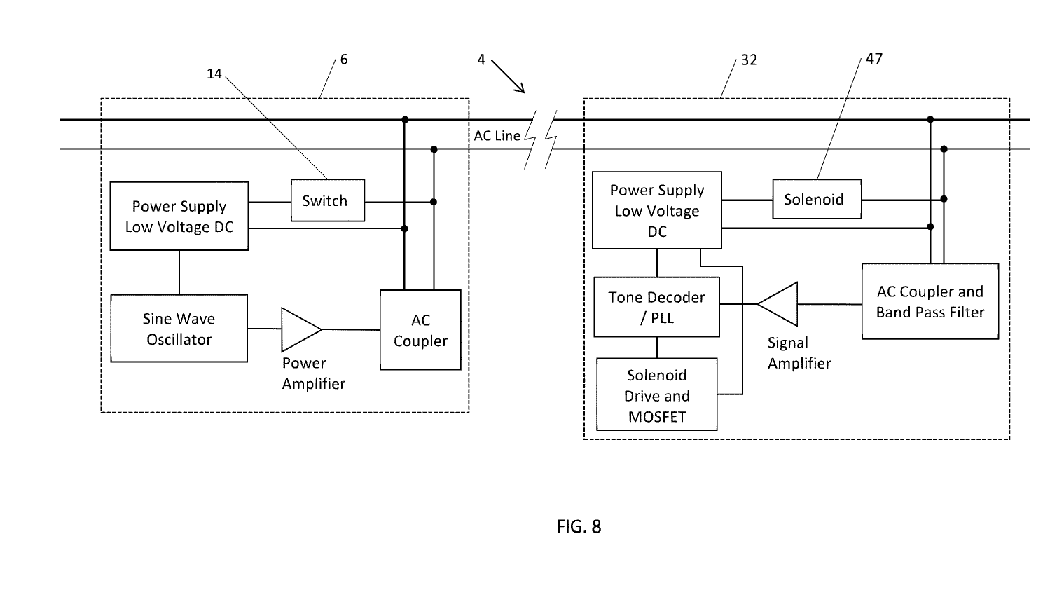

As shown in FIG. 1i, a plurality of electrical cords may be connected in series, the male plug of one cord connected to the female plug of the previous cord. The male plug of each cord may be embodied as shown in FIGS. 1c-1h. Any of the six switches in the plurality of cords illustrated may effect selective ejection of any or all of the male plugs. Selective remote ejector control is explained more fully below with respect to FIGS. 8-11.

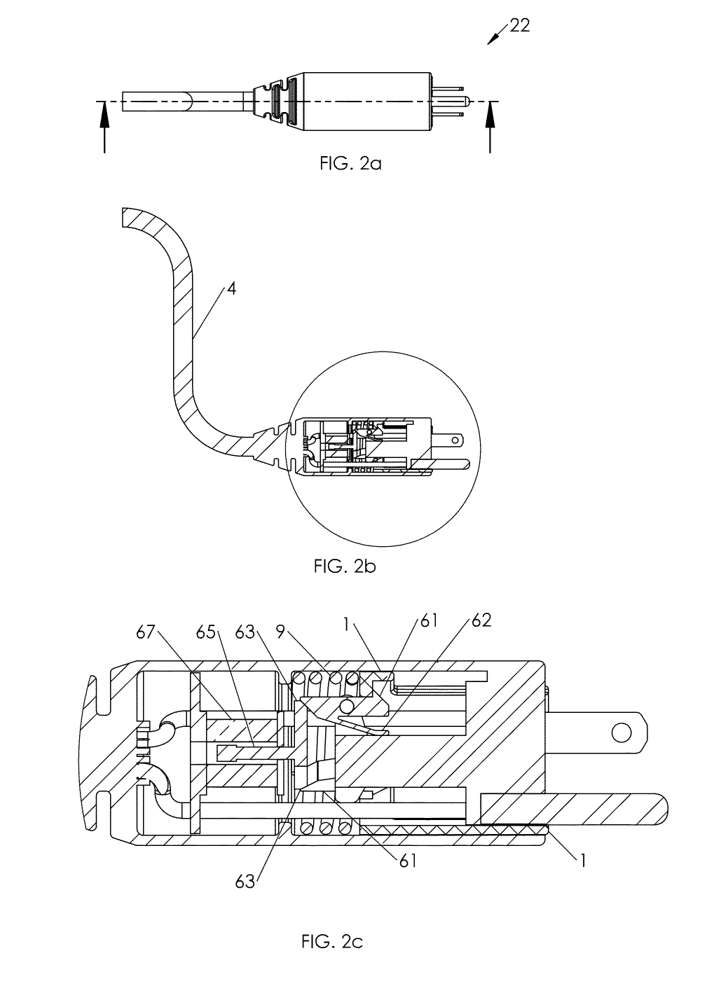

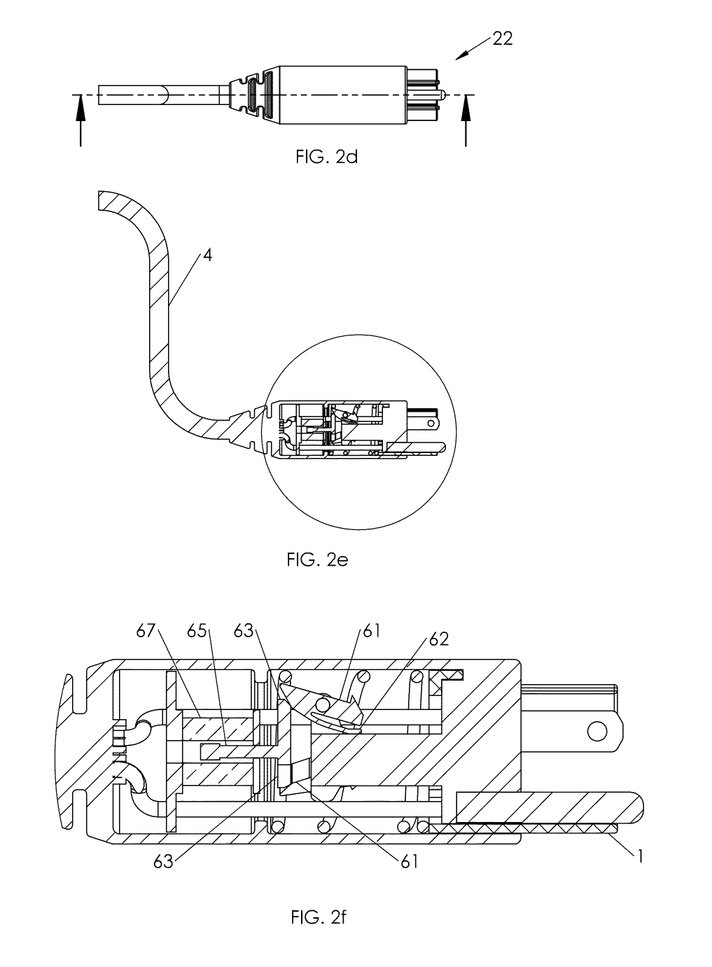

FIGS. 2a-2f are directed to embodiment of the FIGS. 1a-1h, wherein the ejector release mechanism is modified. Components of plug 22 are shown in detail in FIG. 2c for the retracted position of shell 1 and in FIG. 2f for the extended position of shell 1.

Referring to FIG. 2c, solenoid 67 is mounted concentrically within plug 22. Plunger 65 of solenoid 67 is shown positioned when the armature is not energized. Plunger elements 63, extending outwardly in the radial direction, rest against pinned latches 61. Transverse surfaces at the inward end of shell 1 are held in the refracted, or latched, position by latches 11 against the outward force of spring 9. Sprung elements 62 of the latches 61 maintain the pivoted latched positions of latches 61. As arranged in FIG. 2c, the plug may be inserted into a female receptacle for establishing electrical connection.

Plug 22, in the ejected state, is shown in detail in FIG. 2f. In operation, ejection is activated by manual depression of a switch, such as shown in FIGS. 1a, 1b, to effect a switched connection to energize solenoid 67. Plunger 65 is impelled in the axial direction toward latches 61. Plunger elements 63 force latches 61 to pivot until the latches disengage shell 1. The expansion force of spring 9, unimpeded by latches 61, now impels shell 1 to its extended position, ejecting blades 5 and ground prong 3 from the mated connection. Solenoid 65 is de-energized pursuant the plug disconnection. Sprung elements 62 ensure return of latches 61 to their initial position. The plug can be reinserted for a subsequent electrical connection. Shell 1 will be pushed inwardly against latches 11 to overcome the force of spring 9 until the transverse surfaces of shell 1 again are maintained by the latches.

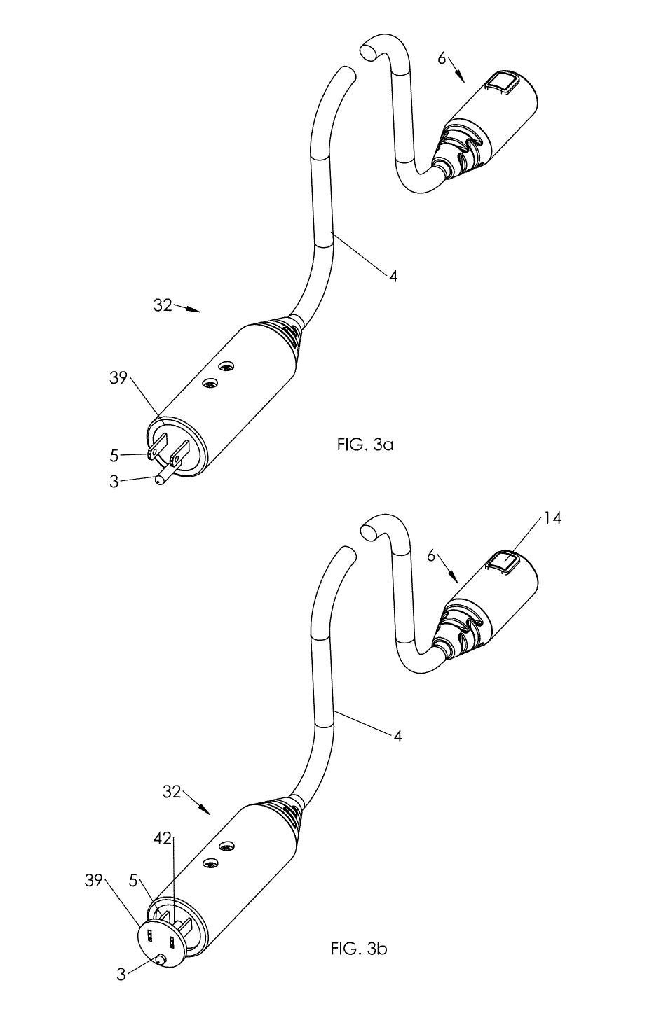

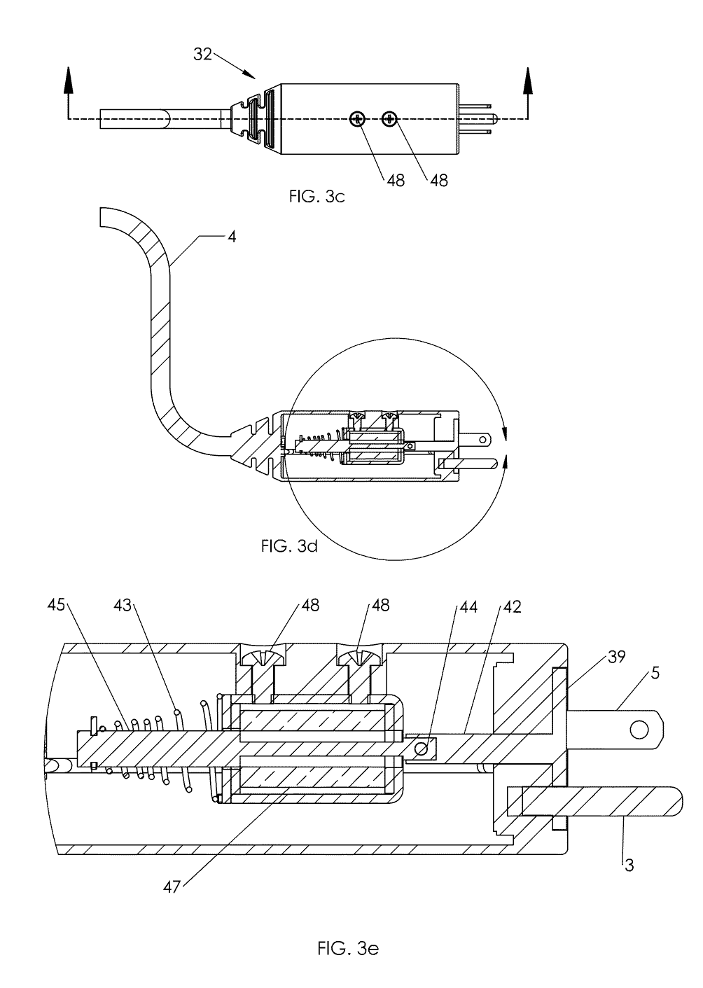

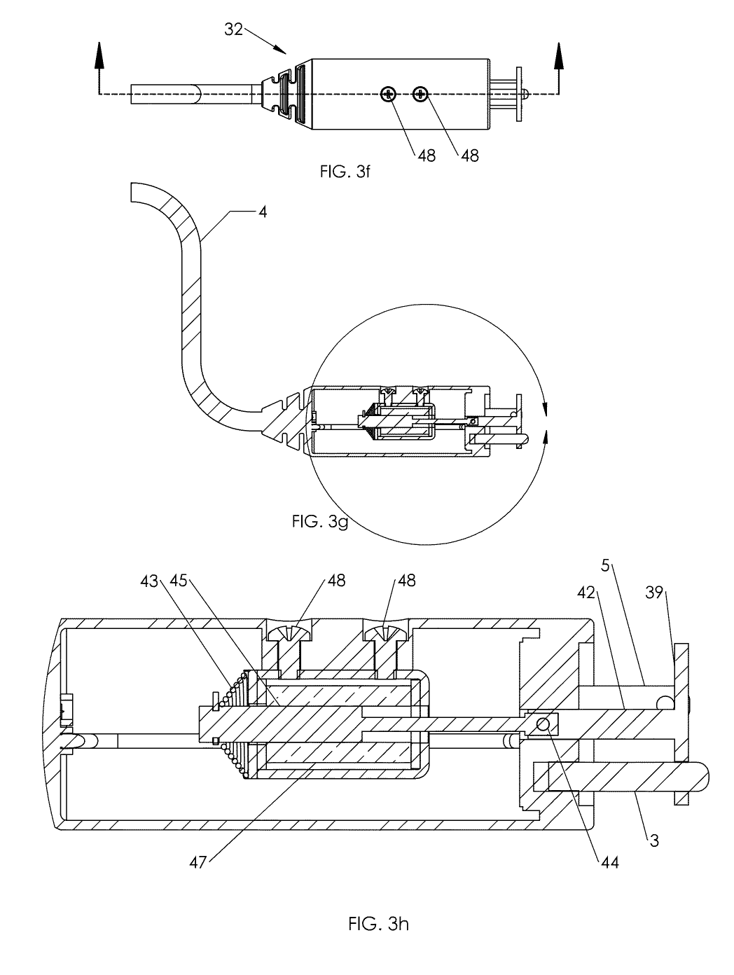

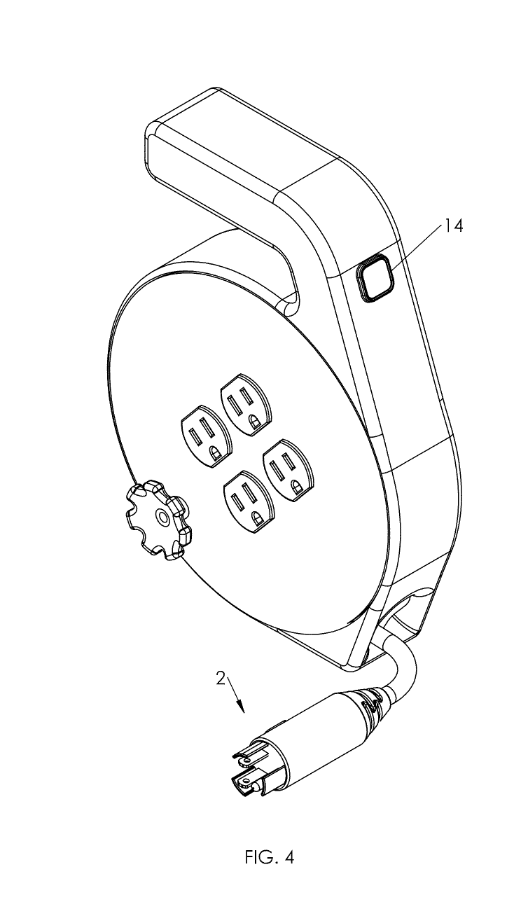

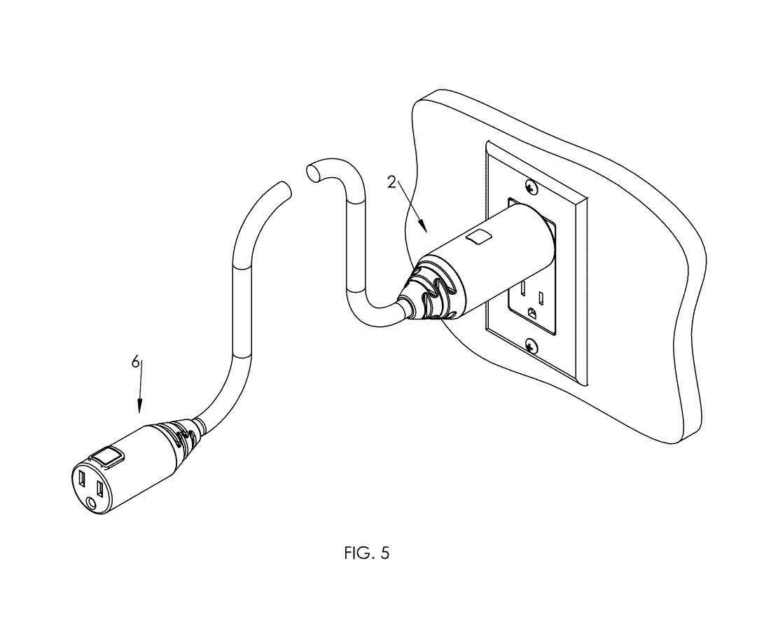

FIGS. 3a-3h are illustrative of an alternative embodiment. Extension cord 32, having a cylindrical male plug 7 at one end and a female plug 6 at the other, is illustrated in FIGS. 3a and 3b. Conductive prongs 5 and ground prong 3 extend from plug 7. Ejector plate 39, with appropriate openings for blades 5, surrounds prongs 5. When ejector plate 39 is retracted within plug 7, as shown in FIG. 3a, blades 5 are able to mate with a female receptacle or plug to establish an electrical connection therewith. When ejector plate 39 is extended from plug 7, as shown in FIG. 3b, a mated connection with plug 7 is precluded. Manual button 14 is tied to a switch component within plug 6. Components of plug 7 are shown in detail in FIG. 3e for the retracted position of ejector plate 39 and in FIG. 3h for the extended position of ejector plate 39.

Referring to FIG. 3e, solenoid 47 is mounted concentrically within plug 7 by screws 48. Plunger 45 of solenoid 47 is shown positioned when the armature is not energized. Ejector plate 39 is fixed to plunger 45 by rod 42 and pin 44. Compression spring 43 is coupled between the fixed armature of solenoid 47 and plunger 45. As arranged in FIG. 3e, the plug may be inserted into a female receptacle for establishing electrical connection.

Plug 7, in the ejected state, is shown in detail in FIG. 3h. In operation, ejection is activated by manual depression of switch 14 to effect a switched connection to energize solenoid 47. Plunger 47 is impelled in the axial direction to drive rod 42 and ejector plate 39 to the extended position with enough force to eject blades 5 and ground plug 3 from the mated connection. Return spring 43 pulls plunger 47 back to the initial position after solenoid 47 is de-energized.

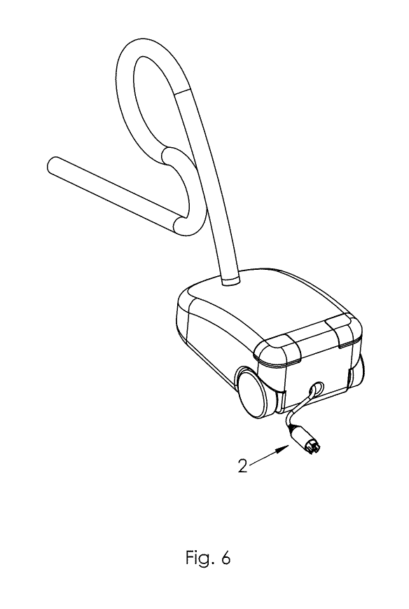

FIGS. 4-6 illustrate examples in which plugs of this disclosure provide advantageous use. An extension cord reel is depicted in FIG. 4 with the cord reeled within its housing. The cord may be reeled out to mate with a female connector at any distance up to the length of the cord. Male plug 2 includes an ejector mechanism such as illustrated in FIGS. 1a-3h. Switch button 14, integrated in the reel housing, can be depressed to activate the male plug ejector mechanism to eject the plug from the mated connection. Such a connection may be made, for example, with a wall receptacle as shown in FIG. 5. Switch 14 may be incorporated with the cord reeling in functionality. FIG. 6 illustrates the ejector plug used to terminate a vacuum cleaner cord. An eject button may be incorporated in the housing or control arm.

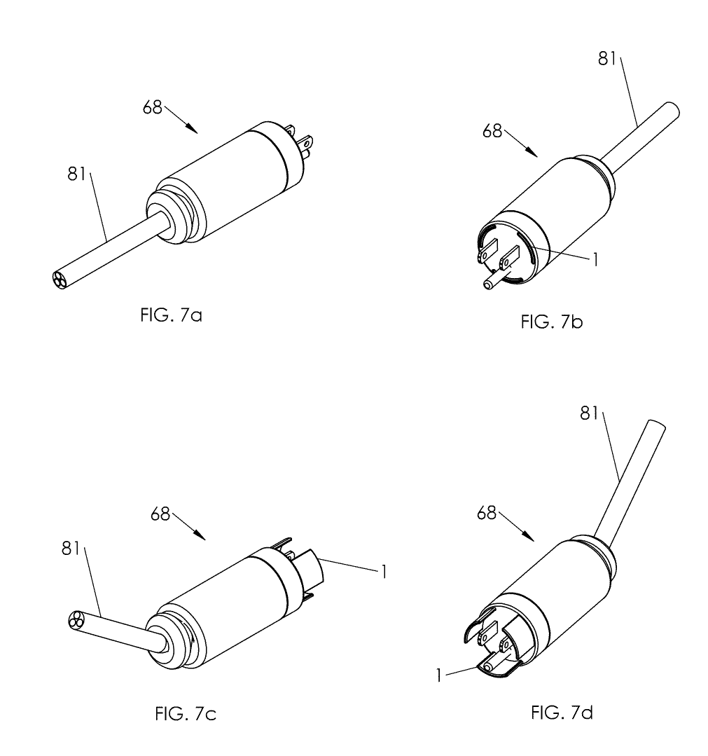

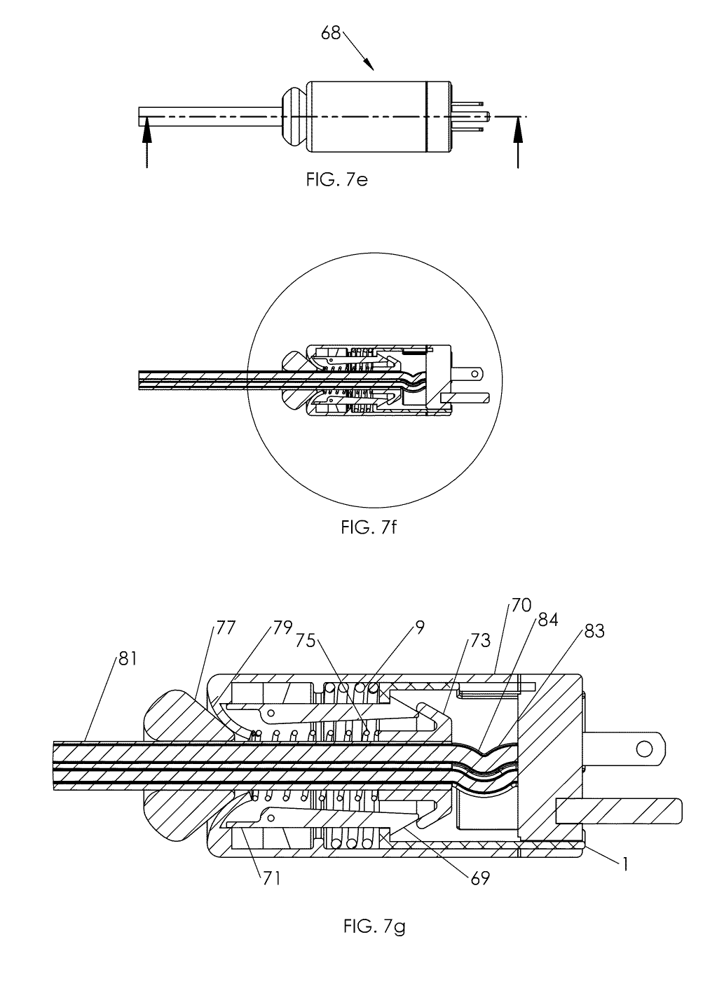

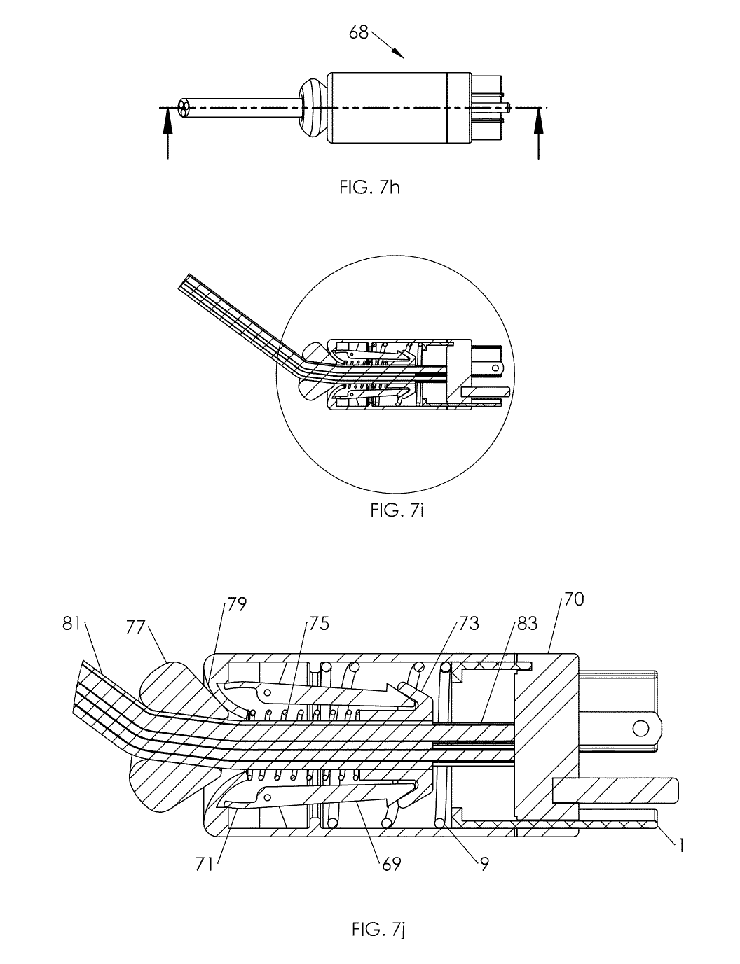

FIGS. 7a-7j are illustrative of an alternative embodiment in which plug ejection occurs in response to inappropriate pulling of the cord. Male plug 68 is illustrated with shell 1 in retracted position in FIGS. 7a and 7b. Plug 68 is shown with shell 1 in extended position in FIGS. 7c and 7d. Components of plug 68 are shown in detail in FIG. 7g for the retracted position of shell 1 and in FIG. 7j for the extended position of shell 1.

Referring to FIG. 7g, cable 81 is in-line with plug 68. Ejector 1 is retracted behind pinned latches 69. Spring 9 is held in compression. Latch release 73 is fixed on cord 81. Latch release 73 is held at a distance from rear portion 79 of the plug housing by latch spring 75. Cone 77, fixed to cord 81, abuts convex surface 79. A stripped portion 83 of cord 81 contains slack 84. An angled pull on cord 81, illustrated in FIGS. 7c and 7d, causes ejection of plug 68, the ejected state of the plug shown in FIG. 7j.

In operation, a pull on cord 81 at an angle to the central plug axis causes cone 77 to rotate on the convex surface 79 of plug housing 70. This rotation pulls on the cord to tighten slack 84. Latch release 73, fixed to cord 81 is pulled back over the ends of latches 69. Latches 69 to pivot toward the central axis against the bias force of spring 75 until shell 1 is free under the ejection force of spring 9. The unlatched shell 1 is then forced into the ejected position by spring 9.

Ejection of the plugs illustrated in FIGS. 1a-3h may be made under remote selective control. Solenoid activation is achieved through signaling over the typical current carrying conductors of the cord itself without the need for a third wire. Such operation is described with reference to FIGS. 8-11.

FIG. 8 is a block diagram of the electrical elements of male ejector plug 32 and female plug 6. It should be understood that the elements of block 6 may, instead, be incorporated in a user device such as the illustrated vacuum cleaner. The control circuits of the two plugs are coupled to each other solely by analog tone communication over the a-c power line conductors 4.

As shown in block 6, serial connection of switch 14 and low voltage d-c power supply are connected across line conductors 4. The d-c power supply is dormant when the switch is in the open state. Depression of switch 14 completes connection of the d-c power supply 4, which is then activated to power the sine wave oscillator. The oscillator output is then amplified and coupled to the a-c coupler to be superimposed on power line conductors 4. The sine wave oscillator may be selectively adjustable to output a desired frequency tone.

As shown in block 32, serial connection of solenoid 47 and low voltage d-c power supply are connected across line conductors 4. An a-c coupler/band pass filter is connected to lines 4 to output the superimposed signal received over line 4 from block 6 when switch 14 is in the closed state. The signal output is amplified and applied to the tone decoder. Solenoid drive and MOSFET circuit and the tone decoder are powered by the low voltage power supply. Upon receipt of the amplified filtered signal the tone decoder applies an output to the solenoid drive circuit to activate the solenoid. Ejection of the plug 32 is then initiated.

The tone decoder may be responsive to a range of signal frequencies or limited in response to a specific tone frequency. In the latter case, plug 32 is associated with a unique identifier frequency that must be paired with the same frequency output by the sine wave oscillator of block 6. In the case of a plurality of serially connected cords, such as illustrated in FIG. 1c, each male plug has a specific identifier. For remote ejector operation, switch 14 may be paired with the particular plug selected by outputting the oscillator signal at the frequency paired for that plug. If ejection of a plurality of plugs, the oscillator may set to output a range of frequencies pairing each of the plugs. When an eject button is depressed all plugs that have been paired with it will eject if they are on the same electrical circuit.

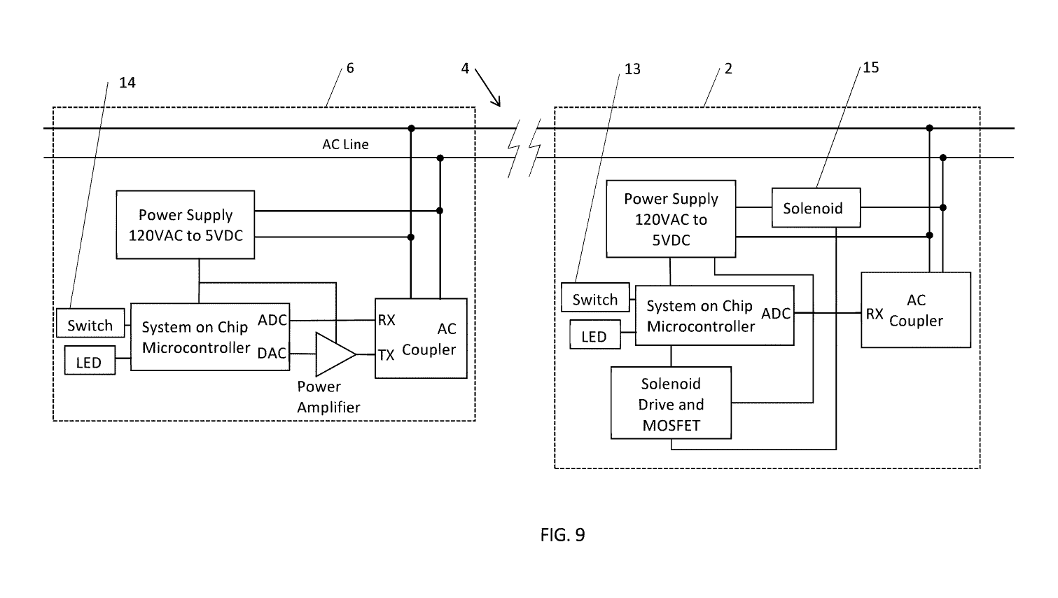

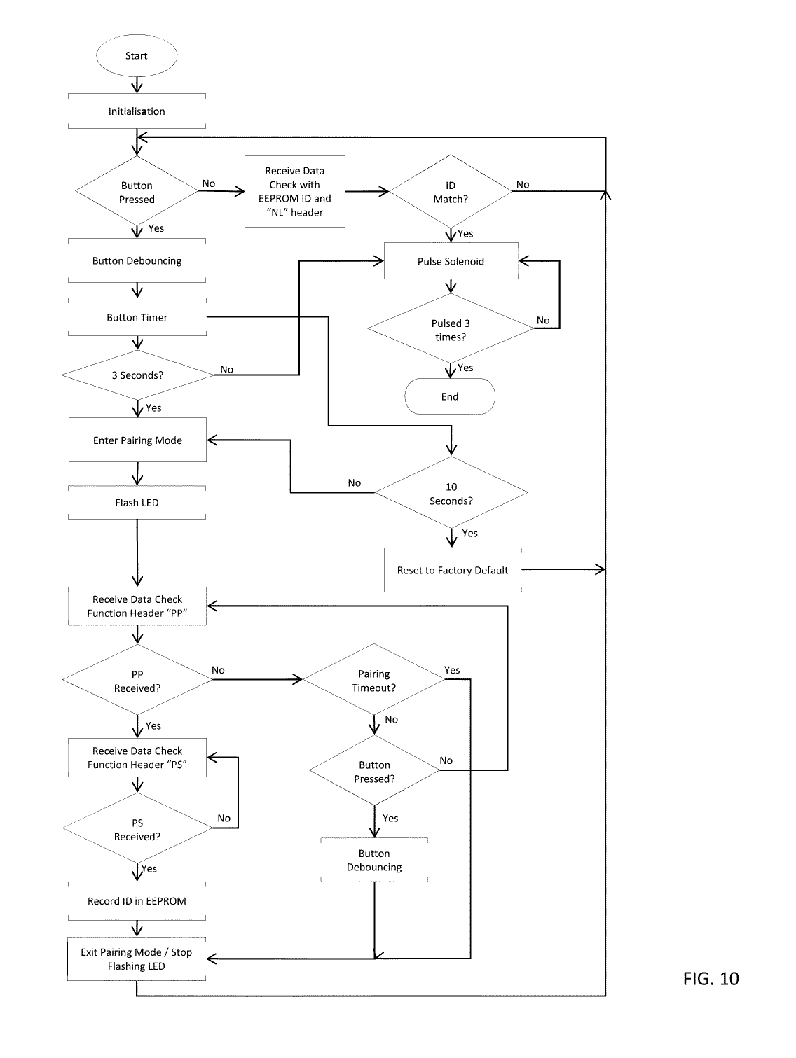

FIG. 9 is a block diagram for digital control of plug ejection, containing digital counterparts of the analog elements of FIG. 8. A-c to low voltage d-c power supply is shown connected across a-c line 4 in block 6. The microcontroller is responsive to a signal from switch 14 to output a signal to the LED. Data outputs are applied by the microcontroller to the power amplifier and AC coupler. The data signal is superimposed on output line 4 by the a-c coupler. Plug 2 contains a microcontroller having an input connected to the a-c coupler. The a-c coupler is connected to the input lines 4 and filters out the a-c component input from lines 4. The microcontroller, powered by the low voltage supply, is responsive to a data signal received from the a-c coupler to activate solenoid 15 if the data signal matches a unique identifier of the plug 6. That is, solenoid activation occurs when the output of block 6 is paired with the data stored on the microcontroller chip.

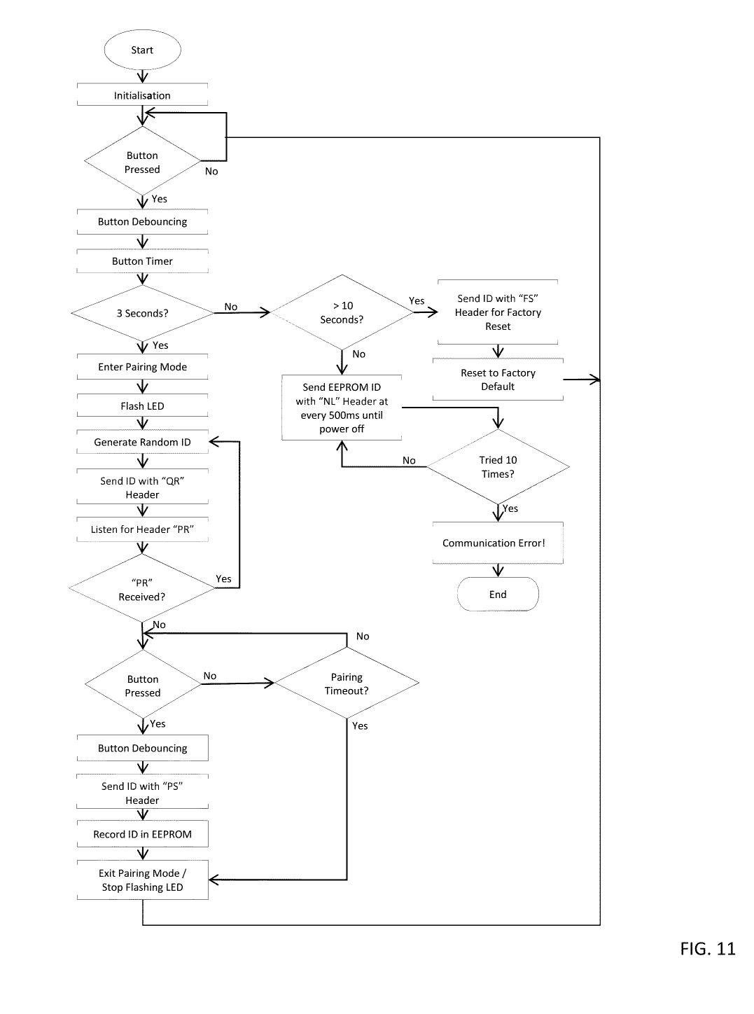

FIG. 10 is a flowchart for the ejection process. FIG. 11 is a flowchart for the pairing process.

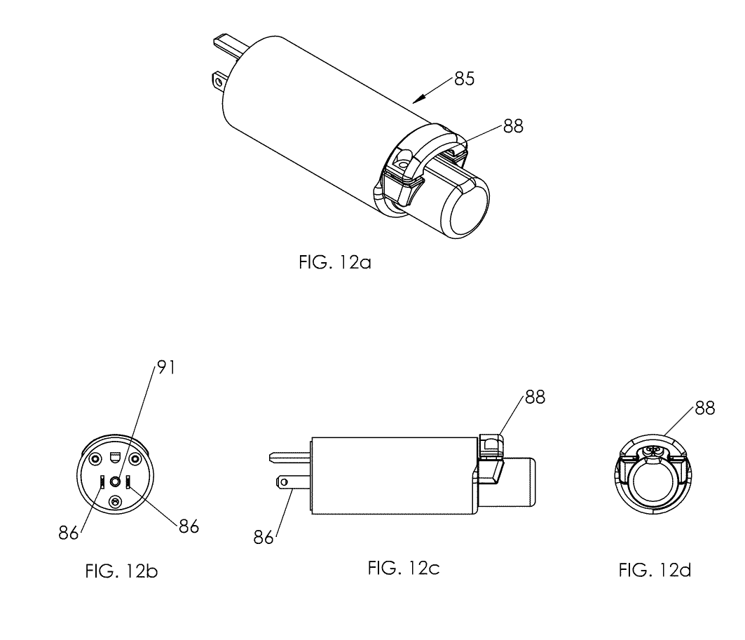

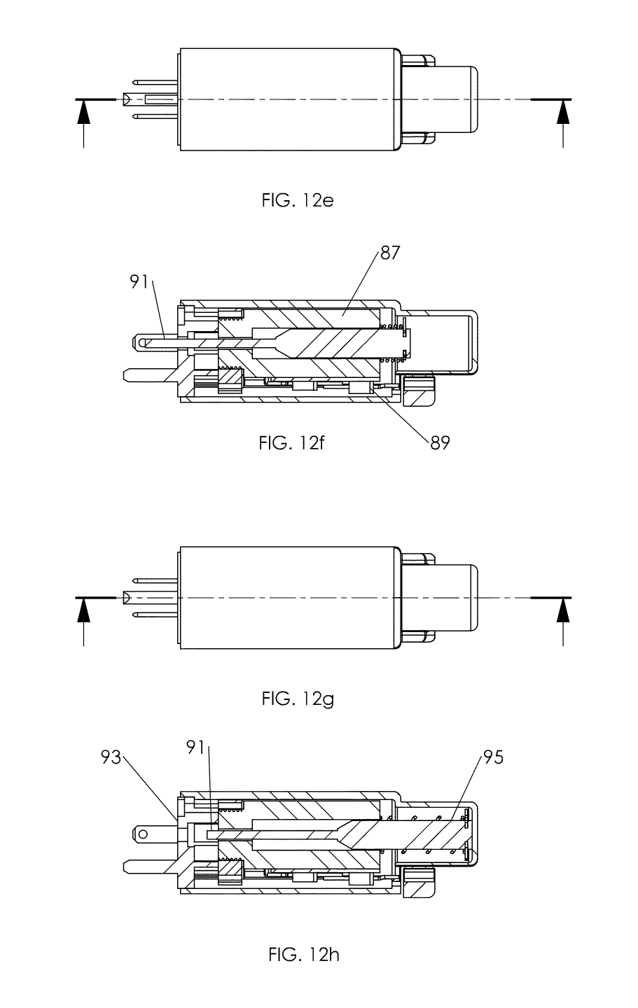

With reference to FIGS. 12a-h, eject plug 85 includes tubular solenoid 87 that is powered by line voltage alternating current supplied through the plug blades 86. Alternating current is converted to direct current by diode bridge 89 to drive ejector rod 91 to the ejected position, as depicted in FIG. 12f. Ejector rod 91 is shown in the retracted state in FIG. 12g. Ejector rod 91 is retracted beyond the front face 93 of plug 85 allowing ejector rod 91 and plunger 95 to accelerate, thereby increasing momentum to impact the receptacle or female outlet to which the plug is connected. Repeated impacts can assist the plug in ejecting from the connection. Cord strain relief clamp 88 may be fastened to the plug enclosure.

In operation, a manual switch remote from the plug, such as activated by button 14 shown in FIG. 4, is normally open to open the circuit to the solenoid during connection of the plug for receiving power. When the plug is to be ejected from its connection, manual operation of the switch to its closed position completes the circuit to the solenoid, thereby energizing the solenoid to drive the ejector rod from the retracted state to the eject state.

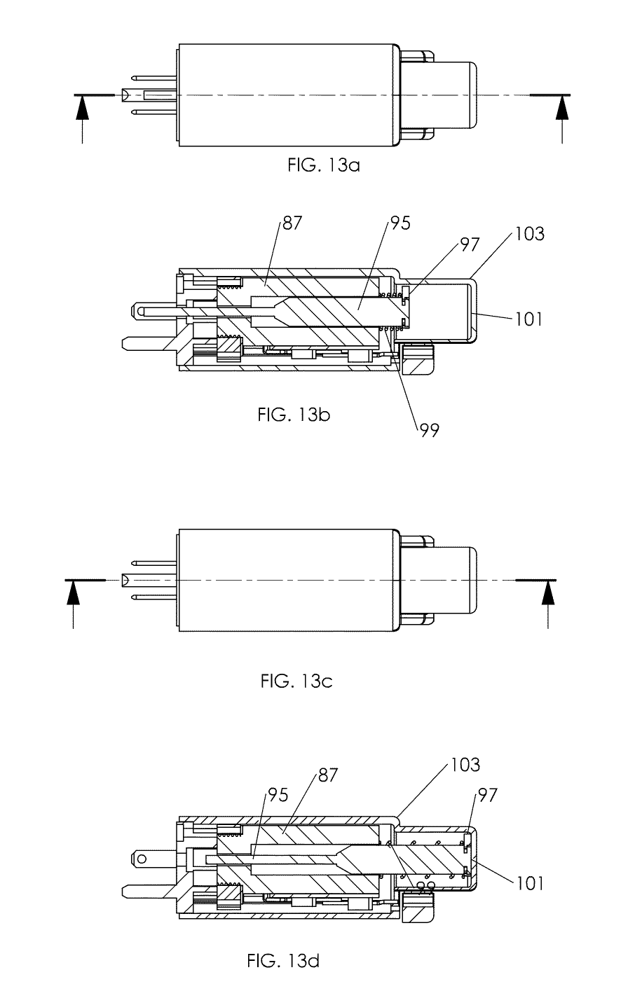

With reference to FIG. 13b, a weighted element 97 is fixed on the end of plunger 95. Element 97 provides the ejector with more momentum, thereby increasing the force on impact on the connected receptacle or female outlet. Spring 99 returns the ejector to its retracted position as seen in FIG. 13d. Plunger 95 and weight 97 are stopped by surface 101 of enclosure 103. The impact of plunger 95 and weight 97 on enclosure 103 transfers the momentum to the plug to assist in ejecting from its connection.

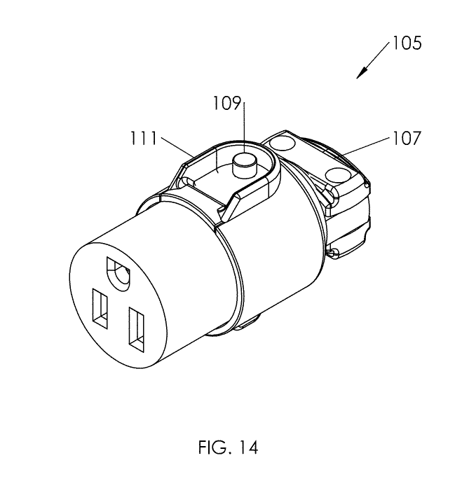

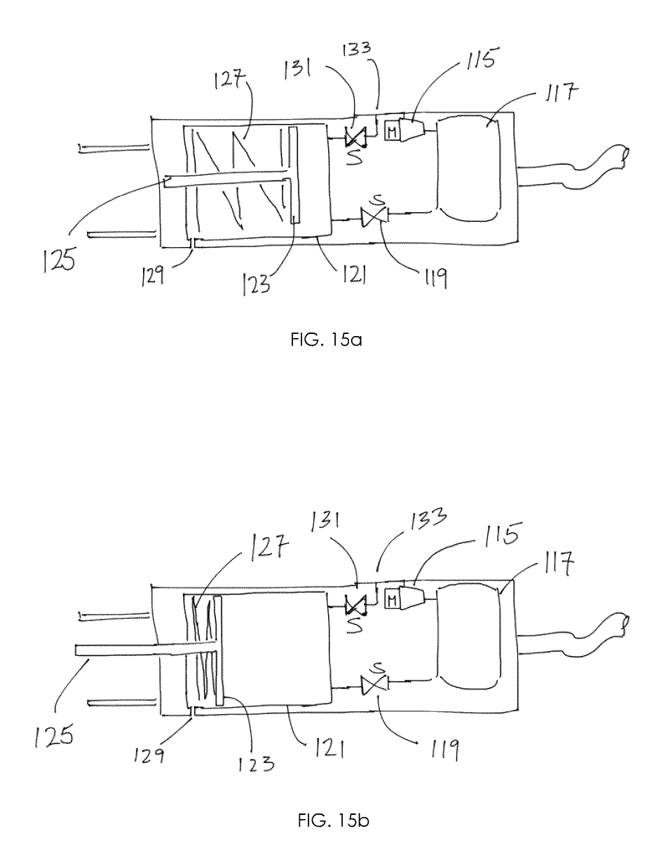

Ejection of the eject plug may be triggered by pushing on button 109 of female plug assembly 105 at the remote end of the electrical cord, as shown in FIG. 14. Stain relief 107 retains the extension cord. Wall 111 portion surrounds button 109 so that it is not depressed inadvertently. Pushing button 109 can momentarily energize the solenoid, or it can trigger repeated pulses that time out after a given number of cycles.

The remote triggering signal is received by a microprocessor in the plug. The processor may be programmed to time out application of a solenoid control signal to avoid burnout of the solenoid coil. The processor may be programmed also to output repeated pulse control signals to the solenoid. Termination of the control signals can occur by virtue of loss of power when plug has been ejected. Flow charts for these processes may be similar to the flow charts exemplified in FIG. 10 and FIG. 11.

FIGS. 15a and 15b depict an eject plug having ejector rod 125 driven by compressed air or gas. FIG. 15a shows the plug in the retracted state while FIG. 15b shows the plug in the eject state. Air is pressurized by motor driven compressor 115 and stored in reservoir 117. Triggering by the remote eject button opens solenoid valve 119, pressuring cylinder 121, driving piston 123 and eject rod 125 into the eject state to push the plug away from the receptacle. Cylinder 121 is vented on the spring side of piston 123 by vent 129. The return spring 127 is compressed. To retract the ejector rod and prepare the plug for reinsertion into a receptacle, solenoid valve 131, vented to atmosphere through vent 133, opens to allow return spring 127 to return the piston 123 and rod 125 to the retracted position. Solenoid valve 131 may be driven by energy stored in a capacitor after the plug has ejected and electric power to the plug is lost. Once inserted into a receptacle and the plug is repowered, compressor 115 re-pressurizes reservoir 117 and the plug is ready for ejection. The remote triggering signal is received by a microprocessor in the plug to take control of the valves 119 and 131.

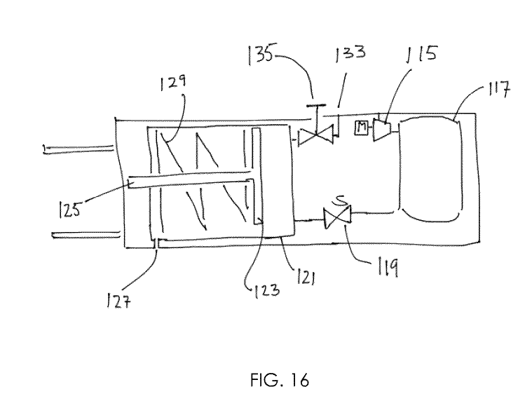

FIG. 16 illustrates a compressed air driven eject plug that is similar to the one shown in FIGS. 15a and 15b. The plug is shown in the retracted state. Valve 135 functions as a bleeder valve when its normally closed switch is manually depressed. Manual activation of vent valve 135 permits pressure to be bled from enclosure after plug ejection. Spring 129 returns the piston 123 and rod 125 to the retracted position.

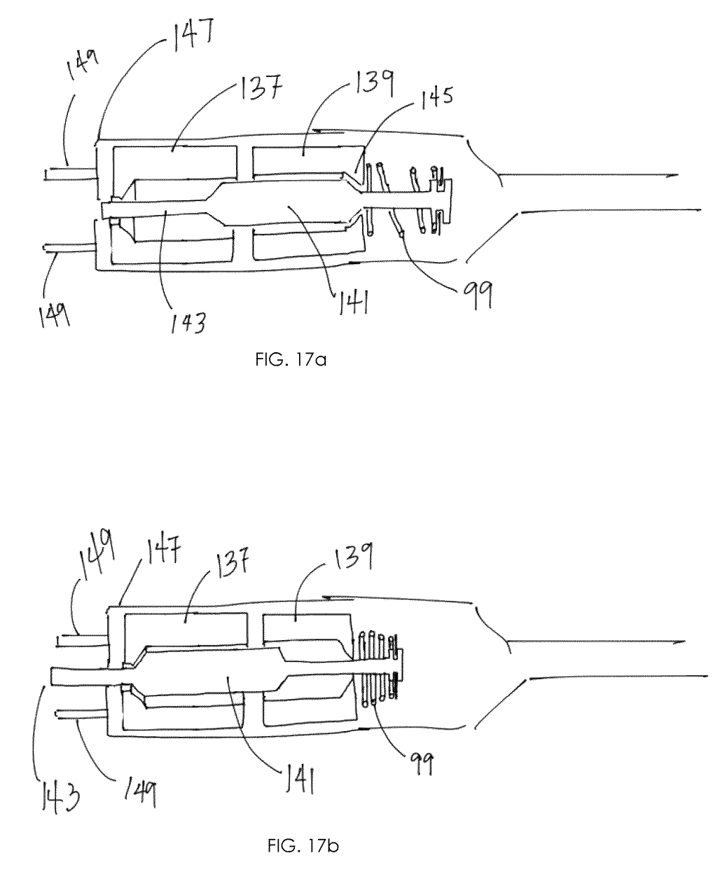

FIGS. 17a and 17b depict a two solenoid reciprocating eject plug. To initiate ejection of the plug, in the state shown in FIG. 17a, from a connected receptacle, the trigger button is pushed. Solenoid 137 is energized, forcing plunger 141 and eject rod 143 to impact the receptacle to eject the plug.

The frictional force of the receptacle contacts on the blades 149 may be too large to permit blades 149 to be completely free of contact with the receptacle contacts. In such event, after a specified delay, solenoid 139 is automatically energized to force plunger 141 to move to the right and come to an abrupt stop against solenoid stop 145, as shown in FIG. 17b. The abrupt stop of weighted plunger 141 and rapid change in momentum incurs a jolt on plug housing 147 and blades 149 to pull further from the receptacle. Cycling of the alternate energizing of solenoid 137 and solenoid 139 will continue automatically until ejection is successful or a time out has been reached. Return spring 99 returns plunger 141 and rod 143 automatically to the retracted state illustrated in FIG. 17a after the solenoids are de-energized. The plug is thus prepared for re-insertion into a receptacle and subsequent ejection.

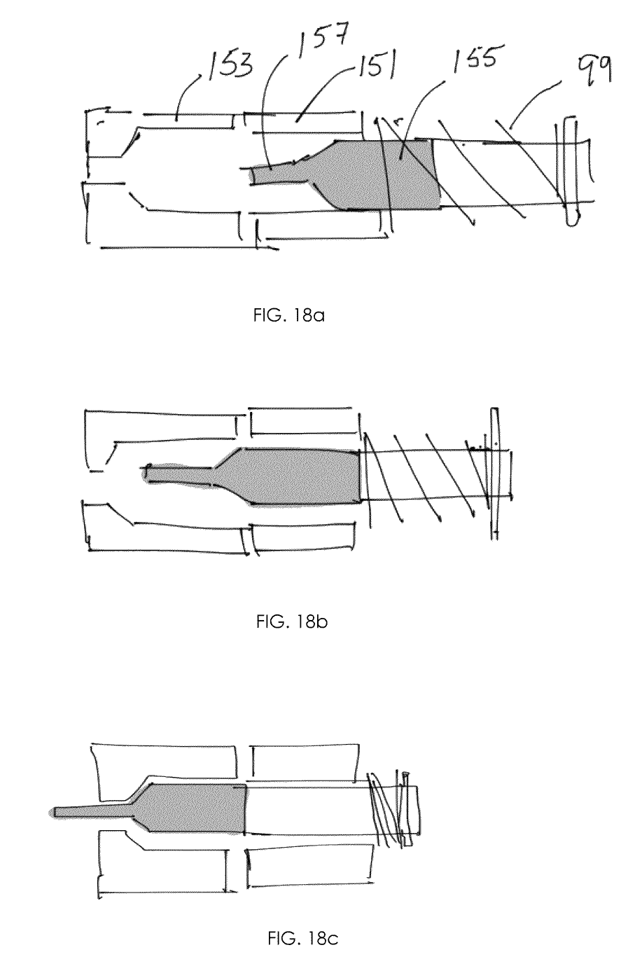

FIGS. 18a, 18b, and 18c depict respective portions of an eject plug embodying two solenoids. Activation of the solenoids in sequence cause the plunger to accelerate stepwise in order to eject the plug. FIG. 18a depicts the plug ready for insertion into a receptacle. In operation, pressing a trigger button begins the eject process. Solenoid 151 is energized, plunger 155 and eject rod 157 are driven to the left and into the state shown in FIG. 18b. Solenoid 151 is then de-energized and solenoid 153 is energized further accelerating plunger 155 and rod 157 to the left to achieve the eject state shown in FIG. 18c. Return spring 99 returns plunger 155 and eject rod 157 to the right in the de-energized state shown in FIG. 18a.

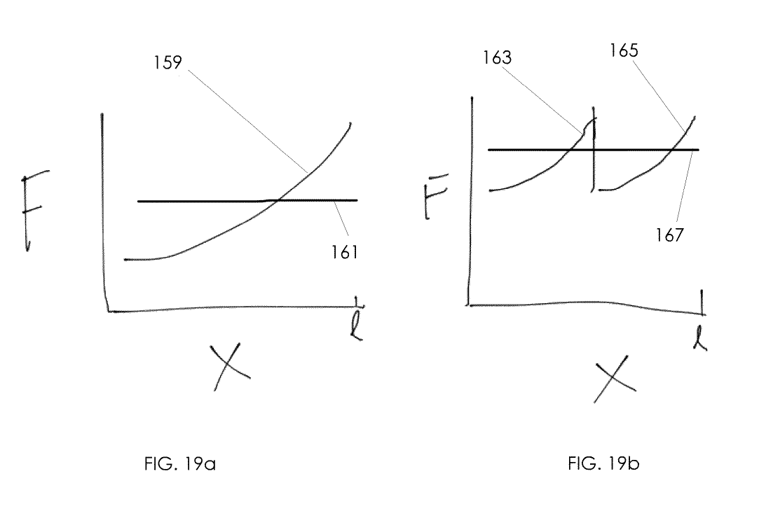

The shorter travel of the plunger in each solenoid makes the force exerted by the solenoid assembly larger than the longer travel required of the single solenoid. This also means that there is a higher average force over its range of motion. FIG. 19a shows the force (F) versus plunger travel (X) curve 159 for a single solenoid and the average force over the travel represented by line 161. FIG. 19b shows the force versus travel curve for the double progressive solenoid assembly shown in FIGS. 18a-c, the first solenoid curve 163 combined with the second solenoid curve 165 produce an average force represented by line 167. The average force for a given plunger travel (l) is greater for the double progressive solenoid assembly than that of the single solenoid giving greater ejection force.

This progressive solenoid embodiment can be extended to include three or more solenoids.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. For example, the diameter of the plug and diameter of the ejector can be increased to allow the ejector to contact the faceplate of a receptacle to further distribute the force of the ejection.

Additionally, the concepts of the present disclosure is not limited to a specific number of alternating current contact blades and may further be applicable to direct current plug devices.

Generation and processing of communication signals may be implemented in accordance with any of known communication protocols. It is further envisioned that wireless signaling technology may be utilized.

What is claimed is:

1. A device comprising:
an electrical plug housing enclosing an inner space extending longitudinally between a front surface and an opposite rear surface, each of said surfaces having an opening therein;
a plurality of conductive blades extending in an outward direction from the front surface, the conductive blades connected to respective wires of an electrical cord, the cord extending outwardly from the housing rear surface to a location remote from the housing; and
an ejector mechanism comprising an ejector rod having a distal end extending outwardly through the opening of the front surface when in an eject position to uncouple the conductive blades from a power terminal, the distal end of the ejector rod retracted within the housing at a predetermined distance from the front surface of the housing when in a retracted position.

2. A device as recited in claim 1, wherein the ejector mechanism further comprises:
a plunger connected in the longitudinal direction to the ejector rod;
a solenoid surrounding the plunger; and
a spring coupled between the plunger and the rear surface of the plug housing, the spring biasing the plunger toward the rear surface of the plug housing;
wherein activation of the solenoid is configured to impart an ejecting force to the plunger.

3. A device as recited in claim 2, wherein the length of inner space of the plug housing in the longitudinal direction exceeds the combined length of the ejector rod and plunger by said predetermined distance.

4. An electrical device as recited in claim 2, further comprising a control circuit having an output connected to the solenoid and an input coupled to the conductive blades.

5. A device as recited in claim 4, wherein the control circuit comprises a manually operable switch operable to energize the solenoid.

6. An electrical device as recited in claim 5, wherein the switch is positioned at the remote location.

7. A device as recited in claim 6, wherein the control circuit comprises a circuit board within the plug housing, the circuit board coupled to the conductive blades to receive an input signal through the switch.

8. A device as recited in claim 7, wherein the circuit board comprises a microprocessor.

9. A device as recited in claim 8, wherein the microprocessor is programmed to output multiple solenoid activation pulses in response to a single remote trigger pulse.

10. A device as recited in claim 8, wherein the microprocessor is programmed to limit the time of an output solenoid activation pulse.

11. A device as recited in claim 5, wherein the manually operable switch is embodied in the plug housing.

12. A device as recited in 11, wherein the plug housing further comprises a wall portion, the wall portion shielding the switch from inadvertent manual activation.

13. A device as recited in claim 2, wherein the plug housing further comprises a weighted element fixed to the plunger.

14. A device as recited in claim 2, further comprising a second solenoid surrounding the plunger.

15. A device as recited in claim 14, wherein the second solenoid is configured to impart a retracting force to the plunger.

16. A device as recited in claim 14, wherein the second solenoid is configured to impart an additional ejecting force to the plunger.

17. A device as recited in claim 1, wherein the device further comprises:
a cylinder embodied within the plug housing;
a piston within the cylinder, the piston joined to the ejector rod;
a spring positioned between the piston and the front surface of the plug housing; and the plug housing inner space further comprises:
a pressurized reservoir; and
a control valve coupled between the reservoir and the cylinder;
wherein activation of the control valve accesses the reservoir to apply pressure to the piston, thereby imparting an ejecting force to the ejector rod.

18. A device as recited in claim 17, wherein the plug housing further comprises a second control valve; wherein activation of the second control valve releases pressure in the inner space of the plug housing, the ejector rod thereby biased by the spring to the retracted position.

19. A device as recite in claim 18, further comprising a microprocessor coupled to the control valves.

20. A device as recited in claim 17, wherein the plug housing further comprises a compressor coupled to the reservoir to replenish the pressure within the reservoir.

21. A device as recited in claim 1, wherein the inner space is generally cylindrical.
